(19) United States
(12) Patent Application Publication
(10) Pub. No.: US 2005/0207425 A1
(43) Pub. Date: Sep. 22, 2005

(54) Method of transmitting uplink packet in base station and mobile communication system implementing the method

(75) Inventor: Ho-Cheol Choo, Yangcheon-Gu (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: CURITEL COMMUNICATIONS, INC., Seocho-Gu (KR)

(21) Appl. No.: 11/079,253

(22) Filed: Mar. 15, 2005

(30) Foreign Application Priority Data
Mar. 17, 2004 (KR) 10-2004-0018152

(51) Int. Cl. H04L 12/56

(52) U.S. Cl. 370/395.52

(57) ABSTRACT

Disclosed is a method of transmitting uplink packet data from a mobile communication terminal to an Internet interface device, wherein a radio access network buffers and accumulates radio link frames received from a mobile station as many as the packet size of an upper layer, and transmits the accumulated frames to the Internet interface device at once.

This application claims priority to Korean Patent Application No. 2004-18152, filed on Mar. 17, 2004, in the Korean Intellectual Property Office, the entire contents of which are hereby incorporated by reference.

### BACKGROUND OF THE INVENTION

1. Field of the Invention

The present invention relates to a data communication technology for mobile communication networks and, more specifically, to a method of transmitting uplink packet data from a mobile communication terminal to an Internet interface device.

2. Description of Related Art

FIG. 1 is a schematic view showing the configuration of a well-known 3GPP2 network. A mobile station (MS) 10 is a mobile communication terminal such as a mobile phone, a wireless application protocol (WAP) terminal, or a mobile communication modem.

A radio access network (RAN) 20, which is also referred to as a radio core network, comprises a base transceiver system (BTS) 21, a base station controller (BSC) 23, and a packet control function (PCF) 25. The BTS 21 includes a baseband processing module, radio equipment, and an antenna. The BSC 23 is responsible for radio resource allocation to a mobile station, and an interconnection between a call control logic and a mobile switching center (MSC) 30. The RAN 20 manages the mobility of the mobile station 10 and authenticates the mobile station 10 through a visitor location register (VLR) and a home location register (HLR) connected to the MSC 30. Also, the RAN 20 is responsible for controlling data transmission between the mobile station 10 and a packet data service node (PDSN) 40 and data buffering between the mobile station 10 and a packet data service node (PDSN) 40.

The PCF 25 is an entity in the RAN 20 that controls the transmission of packets between a base station and the PDSN 40. Also, the PCF 25 provides data buffering and packet segmentation functions so that link layer packets received from the PDSN 40 can be transmitted to the mobile station 10 over an air interface. While the PCF 25 may be incorporated in the BSC 23, it is usually configured as an independent system.

The PDSN 40 provides an access to the Internet, intranets, and WAP servers for the mobile station that uses the RAN 20. The PDSN 40 is responsible for the establishment, maintenance and termination of a Point-to-Point Protocol (PPP) session towards the mobile station 10, and operates as an Internet interface device responsible for interfacing with a wireline Internet network.

In the mobile communication network constructed as described above, when the mobile station requests a packet data service, the PDSN 40 which is to transmit the packet data is determined by the BSC 23 and PCF 25. At this time, a radio traffic channel and a radio link protocol (RLP) are established on a radio link between the mobile station 10 and the BSC 21. An A8 traffic link is established between the BSC 23 and the PCF 25 to transfer PPP link data between the mobile station 10 and the PDSN 40. In addition, an A10 R-P link is established between the PCF 25 and the PDSN 40 to transfer the PPP link data between the mobile station 10 and the PDSN 40. Here, the packet data service in an ‘active’ state implies that the mobile station 10 occupies a radio traffic channel, maintains the RLP link and the A8 link, and transmits/receives packet data.

FIG. 2 is a schematic view showing a protocol stack for data call transfer in a conventional mobile communication system. The protocol stack includes a physical layer, a RLP, a PPP, an Internet Protocol (IP), a Transmission Control Protocol (TCP), a User Datagram Protocol (UDP), etc.

The physical layer is the lowest layer in an Open System Interconnection Reference Model (OSI Reference Model), an International Standards Organization (ISO) standard for worldwide communications that defines a framework for implementing protocols in seven layers.

The physical layer, which is implemented in hardware, defines all electrical and physical specifications for devices. IS-95B/2000 protocol 109 corresponds to the physical layer.

The RLP 107 is used to provide reliable data service over the air interface between the MS 10 and a base station. The RLP 107 also employs an Automatic Repeat Request (ARQ) scheme to request retransmission of messages which have errors or fail to arrive in order to ensure reliable transfer of data.

The PPP 105 is a communication protocol that is used to connect to the Internet or the like using a high speed modem through a dedicated line or a public line.

The IP 103 is a data-oriented protocol used by source and destination hosts for communicating data across a packet-switched internetwork. The IP 103 specifies the format of packets, also called datagrams, and the addressing scheme.

The TCP is a connection-oriented, reliable delivery byte-stream transport layer protocol. Whereas the IP 103 protocol deals only with packets, the TCP enables two hosts to establish a connection and exchange streams of data. The TCP guarantees delivery of data and also guarantees that packets will be delivered in the same order in which they were sent. The UDP is an alternative to the TCP and, together with IP, is sometimes referred to as UDP/IP. Like the TCP, the UDP uses the IP 103 to actually get packets from one computer to another. Unlike TCP, the UDP does not provide the service of dividing a message into packets (datagrams) and reassembling it at the other end. Specifically, the UDP does not provide sequencing of the packets that the data arrives in. This means that the application program that uses UDP must be able to make sure that the entire message has arrived and is in the right order.

The mobile station 10 establishes a session with a communication network connection unit such as the PCF 25 using the physical layer and the RLP. The mobile station 10 establishes a PPP session with the PDSN 40. The mobile station 10 establishes a session with a supplementary service unit, which is provided in a mobile communication service system, using the TCP/IP or UDP/IP. Wireless data communications using the TCP/IP or UDP/IP is available only when a PPP connection is established between the mobile station 10 and the PDSN 40.

Conventionally, in an upper link transmission of such a CDMA communication network, the base station transmits an RLP frame received from the mobile station 10 to the PCF 25 through an A8 interface protocol. At this time, the RLP transmission is data transmission/reception on a radio link between the mobile station and the base station. Since the data transmission is based on a NACK (Negative ACKnowledgement) scheme, a payload of an RLP frame transmitted to the RAN 20 from the mobile station is regarded as having been normally received if NACK does not occur.

A size of the RLP frame transmitted at this time ranges from 22 bytes to 44 bytes. Accordingly, the IP packet having a size of up to 1500 bytes is divided into a plurality of RLP frames to be transmitted from the mobile station to the PDSN 40. Meanwhile, the packet transmission between the base station and the PDSN complies with A8/A10 interfaces used for user data and A9/All interfaces used for control messages. Since an A8/A10 header has a size of at least 42 bytes including a GRE header with a size of at least 8 bytes, an IP header with at least 20 bytes, a link layer header with at least 14 bytes in the case of an Ethernet, the substantial transmission efficiency when transmitting one RLP frame is about 50% at most. There is no doubt that this situation will bring about serious problems in network throughput in the near future when one considers the rapid increase in the volume of uplink data transmission.

### SUMMARY OF THE INVENTION

The present invention provides a method of transmitting an uplink packet from a mobile station to an Internet interface device, which is capable of improving transmission efficiency.

The present invention also provides a method of transmitting an uplink packet from a mobile station to an Internet interface device, which is capable of improving transmission efficiency without changing the configuration of a mobile station.

In accordance with an aspect of the present invention, there is provided a method of transmitting an uplink packet where a radio access network transmits radio link frames received from a mobile station to an Internet interface device side, wherein the radio access network buffers and accumulates the radio link frames received from the mobile station as many as the packet size of an upper layer, and transmits the accumulated frames at once.

The method may comprise the steps of: obtaining size information of the upper layer packet; buffering the radio link frames received from the mobile station until the total size of the received frames corresponds to the size information; and transmitting the buffered frames according to an interface protocol with an Internet interface device side.

The step of obtaining the size information of the upper layer packet may comprise the step of detecting a header of the upper layer packet and extracting the size information included in the header.

The method may comprise the steps of: buffering the radio link frames transmitted from the mobile station from the start to the end of the upper layer packet; and transmitting the buffered frames at once according to the interface protocol of the Internet interface device side.

The upper layer may be an IP layer or a PPP layer.

In accordance with another aspect of the present invention, there is provided a radio access network system, wherein radio link frames received from a mobile station are buffered and accumulated as many as the packet size of an upper layer, and transmitted to an Internet interface device at once.

The radio access network system may comprise: a radio link unit for processing the reception of the radio link frames from the mobile station; and a frame buffer unit for obtaining the packet size of the upper layer from the radio link frames received by the radio link unit, accumulating payloads of the received radio link frames as many as the obtained packet size in a transmission buffer, assembling the received payloads into a single payload, and transmitting the payload to the Internet interface device side.

The frame buffer unit may detect a header of the upper layer packet, extract size information included in the header, and obtain the packet size of the upper layer.

The radio access network system may comprise: a radio link unit for processing the reception of the radio link frames from the mobile station; and a frame buffer unit for accumulating payloads of the radio link frames received from the start to the end of the upper layer among the radio link frames received by the radio link unit in a transmission buffer, assembling the accumulated payloads into a single payload, and transmitting the payload to the Internet interface device side.

The upper layer may be an IP layer or a PPP layer.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view showing the construction of a well-known 3GPP2 network;

FIG. 2 is a schematic view showing a protocol stack for data call transfer in a conventional mobile communication system;

FIG. 3A is a schematic view showing the construction of a mobile communication system in accordance with an embodiment of the present invention;

FIG. 3B is a schematic view showing the construction of a mobile communication system in accordance with another embodiment of the present invention;

FIG. 4A is a schematic flowchart showing a method of transmitting an uplink packet of a base station in accordance with the embodiment shown in FIG. 3A; and

FIG. 4B is a schematic flowchart showing a method of transmitting an uplink packet of a base station in accordance with the embodiment shown in FIG. 3B.

### DETAILED DESCRIPTION OF THE INVENTION

Exemplary embodiments of the present invention will now be described below in more detail with reference to the accompanying drawings. Like numerals refer to like elements throughout the specification.

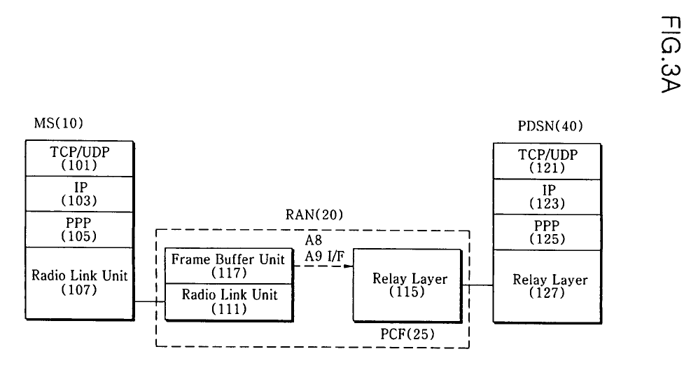

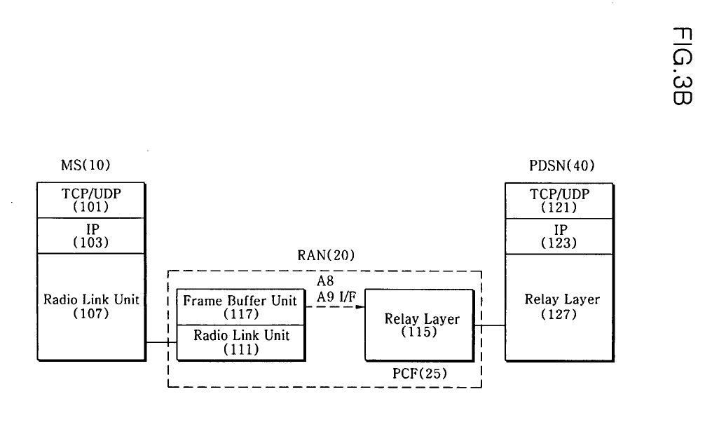

FIG. 3A is a schematic view showing the construction of a mobile communication system in accordance with an embodiment of the present invention. A RAN 20 buffers and accumulates RLP frames received from a mobile station as many as the packet size of an upper layer, and in turn transmits them to an Internet interface device side.

In accordance with the present embodiment of the present invention, a base station of the RAN 20 has a frame buffer unit 117 in addition to a radio link unit 111 which corresponds to a physical layer 113 and an RLP layer 111 and processes the reception of the RLP frame from the mobile station. The frame buffer unit 117 accumulates, in a transmission buffer, payloads of the RLP frames received from the start to the end of an upper layer among the radio link frames received by the radio link unit, assembles the accumulated payloads of the RLP frames into a single payload, and transmits the payload to an Internet interface device side.

In accordance with the present embodiment, the upper layer indicates a PPP layer. In the PPP layer corresponding to a link layer, the start and end of each PPP frame are identified by an ‘Ox7E’ identifier. A single PPP frame is divided into a number of RLP frames and transmitted in the mobile station. The frame buffer unit 117 detects the start of the PPP packet by detecting the ‘Ox7E’ identifier from the received RLP frame. Subsequently, the frame buffer unit 117 stores and accumulates a payload of the received RLP frame in a transmission buffer. When the ‘Ox7E’ identifier is detected from the received RLP frame once again, the frame buffer unit 117 assembles the payloads accumulated in the transmission buffer into one payload and transmits the payload to the Internet interface device side.

At this time, the frame buffer unit 117 assembles data received via an A8 interface with a PCF into one payload and transmits the payload. According to 3GPP2 standard, the A8 interface is an interface standard for user traffic, and the A9 interface is used to provide a signaling connection between a BSC and the PCF for packet data services. A relay layer 115 corresponding to the PCF transfers the user traffic received from the base station through the A8 interface to the PDSN 40 that is the Internet interface device through the A10 interface.

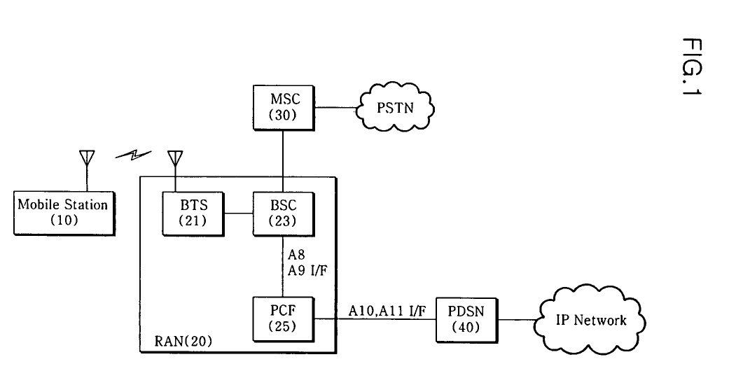

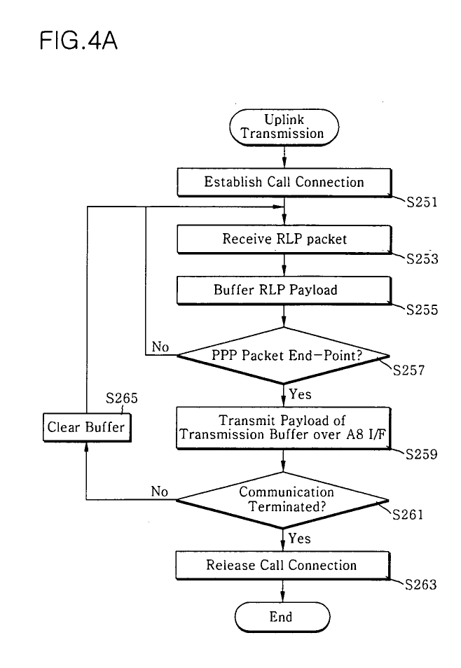

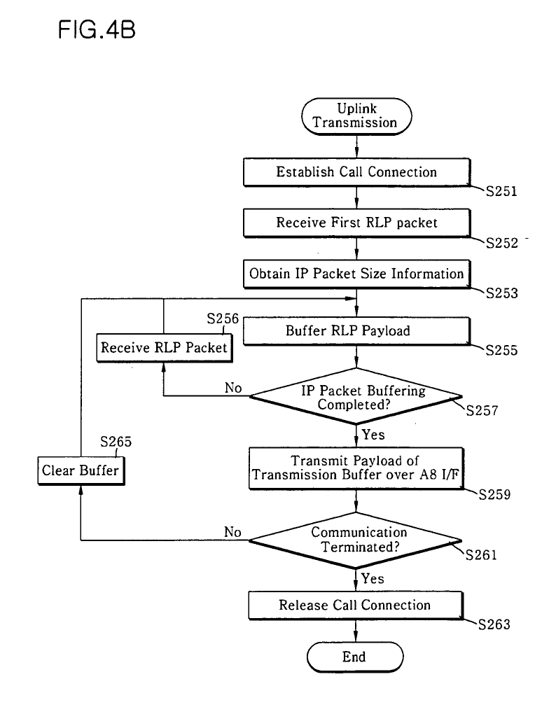

FIG. 4A is a schematic flowchart showing a method of transmitting an uplink packet of a base station in accordance with the embodiment shown in FIG. 3A. The method of transmitting a packet in accordance with the present invention starts with a call setup between the mobile station 10 and the PDSN 40 shown in FIG. 1 (step S251). The call setup process is well known in the 3GPP2 network and the present invention is performed in a packet data service ‘active’ state, and a detailed description thereof will thus be omitted. Next, the base station processes the reception of the RLP frame (step S253). The first RLP frame to be received includes the ‘Ox7E’ identifier. That is, since it is the start of the PPP packet, the base station starts to buffer a payload part of the RLP frame in an empty transmission buffer that is initialized (step S255). If an ‘Ox7E’ byte is not detected from the RLP frame again, that is, if the end of the PPP frame being an upper layer is not detected, the above-mentioned buffering process is repeated (step S257). In this way, the RLP frames originated in the mobile station are buffered from the start to the end of a PPP packet being an upper layer of the RLP frame. If the ‘Ox7E’ byte is detected and the end of the PPP packet is detected, the payload stored in the transmission buffer is transmitted to the PCF 25 at once according to the A8 interface protocol. When communication termination is not requested by the mobile station, the transmission buffer is cleared (step S265), and the above-mentioned steps are repeated starting with step S253 (step S261). When communication termination is requested, a call release process is performed between the mobile station 10 and the PDSN 40 according to well-known signal rules (step S263)

FIG. 3B is a schematic view showing the construction of a mobile communication system in accordance with another embodiment of the present invention. According to the present embodiment, the base station of the RAN 20 buffers and accumulates the RLP frames received from the mobile station as many as the packet size of an upper layer, and transmits the frames to the PCF of the Internet interface device at once. Compared with the embodiment of FIG. 3A, the present embodiment manages a connection between the mobile station 10 and the PDSN 40 without using the PPP protocol.

The above-mentioned call connection setup is described in detail in Korean Patent Application No. 2003-75624 invented by the inventor of the present invention and filed by the applicant of the present invention.

A method of establishing a call connection without a PPP layer comprises the steps of establishing a traffic channel between the mobile station 10 and the RAN 20, establishing a virtual connection between the RAN 20 and the Internet interface device 40, allowing the Internet interface device 40 to transmit IP information to the mobile station 10 without establishing a PPP connection, and allowing the mobile station 10 and the Internet interface device 40 to exchange the IP packet via the RAN 20. At this time, processes including IP information transmission performed during a PPP session connection can be performed using a broadcast/multicast IP packet.

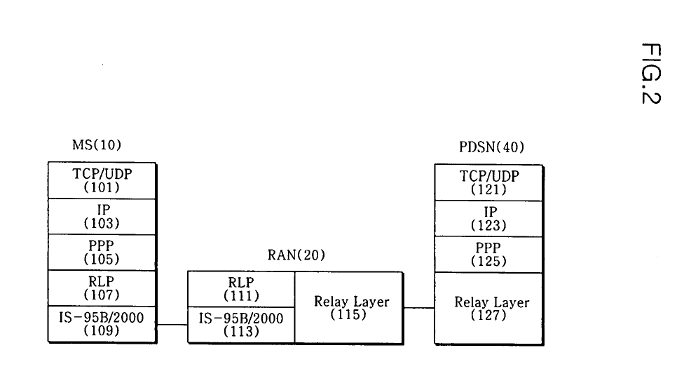

In accordance with the present embodiment of the present invention, the base station of the RAN 20 includes a frame buffer unit 117 in addition to the radio link unit 111 that corresponds to the physical layer 113 and the RLP layer 111 which are shown in FIG. 2 and processes the reception of the RLP frames from the mobile station.

The frame buffer unit 117 acquires the packet size of an upper layer among the frames received from the radio link unit 111, accumulates the RLP frames as much as the packet size in the transmission buffer, and assembles the received data into one payload and transmits the payload to the PDSN 40 being the Internet interface device, that is, the PCF 25. Since the PDSN 40 processes the packets finally received by unit of the IP packet, it is preferable that the packets transmitted from the base station be transmitted in the IP packet size. The size of the IP packet is not usually changed if it is determined in the entire system including a wireline network.

According to the present embodiment, the upper layer indicates an IP layer. The IP packet header includes size information of the IP frame. According to the present embodiment, the frame buffer unit 117 detects the header of the IP packet serving as an upper layer from the received RLP frame, and discovers the size of the IP packet from the size information included in the header. Next, the frame buffer unit 117 stores and accumulates the payloads of the received RLP frames in the transmission buffer starting with the payload of the RLP frame including the size information of the IP packet until the size of the payloads of the RLP frames corresponds to the size information. When the payloads stored in the transmission buffer equals the length of the IP packet, the frame buffer unit 117 assembles the payloads accumulated in the transmission buffer into one payload, and transmits the payload to the Internet interface device side.

At this time, the frame buffer unit 117 in accordance with the present embodiment assembles the data received via the A8 interface with the PCF into one payload, and transmits the payload. The absence of the PPP layer has minimal effect upon the interface in the packet data service ‘active’ state.

FIG. 4B is a schematic flowchart showing a method of transmitting an uplink packet of a base station in accordance with the embodiment shown in FIG. 3B. The method of transmitting a packet in accordance with the present invention starts with a call setup performed by the mobile station 10 and the PDSN 40 shown in FIG. 1 (step S251). Such a call setup process is well known in the 3GPP2 network and the present invention is performed in a packet data service ‘active’ state, and a detailed description thereof is thus omitted.

Next, the frame buffer unit 117 obtains size information of an upper layer packet. That is, it detects the header of the IP packet of the IP layer (upper layer), and extracts the size information included in the header. First, the RLP layer of the radio link unit 111 processes the reception of the first RLP frame (step S252). The first RLP frame to be received includes a starting part of the first IP packet, i.e., header information, and the header information includes the size information of the IP packet. The frame buffer unit 117 obtains the size information of the IP packet in the IP layer (upper layer) from the header information (step S253).

Next, the frame buffer unit 117 buffers the radio link frames originating from the mobile station until the frames corresponding to the size information are received. That is, the frame buffer unit 117 starts to buffer the payload part of the received RLP frame in an empty transmission buffer that is initialized (step S255). Such a buffering process is repeated until the RLP frames are received as many as the size of the IP packet (step S257). If the IP packet is not completely received, the next RLP frame is received and the process is returned to step S255 to repeat the above-mentioned steps. In this way, the RLP frames originated in the mobile station are buffered from the start to the end of the IP packet (upper layer) in the RLP frame.

If the payloads are accumulated in the transmission buffer as many as the size of the IP packet, i.e., if one IP packet is completely received, the frame buffer unit 117 transmits the payload stored in the transmission buffer to the PDSN side being the Internet interface device, that is, the PCF 25 at once according to the A8 interface protocol. When communication termination is not requested by the mobile station side, the transmission buffer is cleared (step S265), and the above-mentioned steps are repeated starting with step S253 (step S261). When the communication termination is requested, a call release process is performed between the mobile station 10 and the PDSN 40 according to well-known signal rules (step S263).

As described above, in accordance with the present invention, since payloads obtained from the base station through an air interface are collected and grouped from a plurality of RLP frames, and transmitted between the BTS and the BSC at once, it is possible to enhance the transmission efficiency between the base station and the packet control function.

Further, it is possible to enhance the transmission efficiency between the base station and the packet controller in a new protocol based on a mobile IP in the future.

While the present invention has been described with reference to exemplary embodiments thereof, it will be understood by those skilled in the art that various changes in form and details may be made therein without departing from the scope of the present invention as defined by the following claims.

1. A method of transmitting an uplink packet where a radio access network transmits radio link frames received from a mobile station to an Internet interface device side, wherein the radio access network buffers and accumulates the radio link frames received from the mobile station as many as the packet size of an upper layer, and transmits the accumulated frames at once.

2. The method of claim 1, comprising the steps of:
obtaining size information of the upper layer packet;
buffering the radio link frames received from the mobile station until the total size of the received frames corresponds to the size information; and
transmitting the buffered frames according to an interface protocol with an Internet interface device side.

3. The method of claim 2, wherein the step of obtaining the size information of the upper layer packet comprises the step of detecting a header of the upper layer packet and extracting the size information included in the header.

4. The method of claim 3, wherein the upper layer is an IP layer.

5. The method of claim 1, comprising the steps of:
buffering the radio link frames transmitted from the mobile station from the start to the end of the upper layer packet; and
transmitting the buffered frames at once according to an interface protocol of the Internet interface device side.

6. The method of claim 3, wherein the upper layer is a PPP layer.

7. A radio access network system, wherein radio link frames received from a mobile station are buffered and accumulated as many as the packet size of an upper layer, and transmitted to an Internet interface device at once.

8. The radio access network system of claim 7, comprising:
a radio link unit for processing the reception of the radio link frames from the mobile station; and
a frame buffer unit for obtaining the packet size of the upper layer from the radio link frames received by the radio link unit, accumulating payloads of the received radio link frames as many as the obtained packet size in a transmission buffer, assembling the received payloads into a single payload, and transmitting the payload to the Internet interface device side.

9. The radio access network system of claim 8, wherein the frame buffer unit detects a header of the upper layer packet, extracts size information included in the header, and obtains the packet size of the upper layer.

10. The radio access network system of claim 9, wherein the upper layer is an IP layer.

11. The radio access network system of claim 7, comprising:
a radio link unit for processing the reception of the radio link frames from the mobile station; and
a frame buffer unit for accumulating payloads of the radio link frames received from the start to the end of the upper layer among the radio link frames received by the radio link unit in a transmission buffer, assembling the accumulated payloads into a single payload, and transmitting the payload to the Internet interface device side.

12. The radio access network system of claim 9, wherein the upper layer is a PPP layer.
